(19) United States
(12) Patent Application Publication
(10) Pub. No.: US 2018/0023164 A1
(43) Pub. Date: Jan. 25, 2018

(54) METHOD FOR PRODUCING NATIONAL-STANDARD MAGNESIUM ALLOY INGOTS ON THE BASIS OF MAGNESIUM ALLOY WASTE MATERIAL

(71) Applicant: Heyi Tan, Xiangtan (CN)

(72) Inventors: Heyi TAN, Xiangtan (CN); Lunyuan TANG, Xiangtan (CN)

(73) Assignee: HUNAN S.R.M SCIENCE AND TECHNOLOGY CO., LTD, Xiangtan (CN)

(21) Appl. No.: 15/677,014

(22) Filed: Aug. 15, 2017

Related U.S. Application Data
(63) Continuation of application No. PCT/CN2015/074840, filed on Mar. 23, 2015.

(30) Foreign Application Priority Data
Feb. 16, 2015 (WO) PCTCN2015073174

(51) Int. Cl. C22B 1/00; C22C 23/02; B08B 3/02; B22D 7/00; C23G 1/12; C22B 26/22; C22C 1/02

(52) U.S. Cl. CPC C22B 1/005; C22B 26/22; C22C 23/02; C22C 1/02; B22D 7/005; C23G 1/12; B08B 3/02

(57) ABSTRACT

A method comprises: sorting and removing impurities from magnesium alloy waste material, and cleaning and drying said material, the cleaning comprising high-pressure rinsing, pickling, and water washing, performed in sequence; preheating the magnesium alloy waste material obtained in step a, and adding material, melting, refining, removing impurities, and alloying to obtain a magnesium alloy liquid; casting ingots from the magnesium alloy liquid obtained in step b, to obtain magnesium alloy ingots conforming to national standards. The method directly takes magnesium alloy waste material as a raw material to produce magnesium alloy ingots conforming to national standards; the addition of costly high-purity magnesium is unnecessary, and the number of castings in which the amount of harmful elements meets specifications accounts for 98% or more of the total number of castings; 2% slightly exceed specifications, which does not constitute a severe number of times specifications are exceeded.

### CROSS REFERENCE TO RELATED APPLICATIONS

This application is a continuation of PCT/CN2015/074840 filed Mar. 23, 2015 and claims priority to PCT/CN2015/073174 filed Feb. 16, 2015, both of which are incorporated herein by reference.

### BACKGROUND OF THE INVENTION

### 1. Technical Field

The present invention relates to methods for recycling magnesium alloy waste material, and more particularly to a method for producing GB-standard magnesium alloy ingots from magnesium alloy waste material. GB standards refer to the Chinese national standards issued by the Standardization Administration of China (SAC), the Chinese National Committee of the ISO and IEC.

### 2. Description of Related Art

Among alloy of nonferrous metals, magnesium alloy is advantageous for having small density, good rigidity, corrosion resistance, impact resistance, friction resistance, good thermal and electric conductivity, and excellent electromagnetic shielding effectiveness, while being unlikely to deform, non-toxic, non-magnetic, damping and easy to mold and recycle. With the same volume, magnesium alloy is 36% lighter than aluminum alloy and 73% lighter than zinc alloy. Magnesium alloy has thus become popular in modern automotive, electronics and telecommunication industries, and is extensively used in various fields, such as aviation, aerospace, electronics, automobile, computer and telecommunication, praised as green engineering material of the 21^{st} century.

Automotive components made of magnesium alloy help to reduce the car's weight, to enhance fuel utilization, and to reduce environmental impact. Making crucial weapons and equipment like airplanes, missiles, airships, satellites, light arms with magnesium alloy means increased weapons ranges and firing accuracy, improved flight vehicle maneuverability, and lowered spacecraft launch costs. Using magnesium alloy to make casings for digital devices such as mobile phones, laptop computers and digital cameras provides benefits like high strength, esthetics and electromagnetic shielding effectiveness. With increasingly extensive use of magnesium alloy in these fields, since the 1990s, globally, use of magnesium has seen a more than 20% growth every year for 10 years in a row. As to output of magnesium, it was 260,000 tons in 1990, 460,000 tons in 2002, and up to 610,000 tons in 2005. However, since metal resources are not renewable, such overexploitation of metal resources goes against the strategy for sustainable development. Besides, the used metal product waste in a huge amount, particularly heavy metal product waste, will continuously contaminate the environment. According to China Nonferrous Metals Industry Association, China produced 769.7 thousand tons of raw magnesium in 2013, namely 10.22% more than the same period in the previous year, and 297.8 thousand tons of magnesium alloy, namely 43.52% more than the same period in the previous year. However, rapid growth of output of magnesium alloy necessarily brings about sharp increase of magnesium alloy waste material. As a solution, recycling discarded and old magnesium alloy products helps to not only reduce the burden of exploitation of metal resources, but also mitigate the natural environment pollution caused by heavy metal product waste, and it thus an issued treated with great importance in China and other countries all around the world. Magnesium alloy waste material is highly recoverable and less energy consuming. Its recovery rate is more than 95%, and the energy consumption for recycle is only 5% of that for raw magnesium production. Therefore, reasonable recovery and reuse of magnesium alloy waste material directly influence the rationally and sustainability of development of magnesium alloy industries.

Sorting and grading magnesium alloy waste material facilitates recycle of magnesium alloy waste material, thereby helping to conserving resources and lowering production costs.

Waste of magnesium and magnesium alloy has eight grades in a draft of international classification standards, as shown in Table A below.

TABLE A
Grades of Waste of Magnesium and Magnesium Alloy

| Grade | Description | Source | Example |
|---|---|---|---|
| 1 | Cleaned and sorted waste | Produced in die-casting | Cakes in runners, |
| | | processes | sprue, burr, |
| | | | flashing and |
| | | | scrapped parts |
| 2 | Cleaned and sorted waste, mixed | Produced in die-casting | Waste castings |
| | with wooden inclusions and steel | processes | containing steel |
| | inclusions | | inclusions |
| 3 | Grade 1 or 2 waste coated or | Produced in die-casting | Rejected castings |
| | smeared with paint or greasiness | processes | |
| 4 | Dry and clean machined debris and | Produced in die-casting | Machined debris |
| | cutting scrap | processing without lubricator | and cutting scrap |
| 5 | Machined debris and cutting scrap | Produced in die-casting | Machined debris |
| | smeared with oil and water | processing with oil or | and cutting scrap |
| | | oil-water emulsion lubricator | |
| 6 | Slag free of salts | Produced in cleaning | Slag |
| | | smelting furnaces | |
| 7 | Slag containing salts | Produced in mold-casting | Slag |
| | | processes under dry | |
| | | condition | |
| 8 | Waste other than those of Grades 1 | | |
| | through 7; alloy of different | | |
| | designations mixed and stored for | | |
| | long time | | |

After sorted and graded, magnesium alloy waste material can be treated differently according its grade: (1) cleaned and sorted waste of Grade 1 can be smelted directly; (2) cleaned and sorted yet mixed therein with wooden inclusions and steel inclusions can only be smelted when the inclusions have been removed; (3) smeared with paint and greasiness must have the paint and greasiness removed before smelted (4) dry, clean machined debris and cutting scrap are pressed into cakes and smelted in furnaces; (5) the best way to recycle machined debris and cutting scrap smeared with grease and water is to perform vaporization in special furnaces under high temperature and vacuum (YANG Ming-bo et al., Development of Recycling Technology of Magnesium Alloy Scraps [J], casting, 2005, 54(5): 420-424). In the prior art, recycling of magnesium alloy waste material mainly refers to recycling of Grades 1 to 5 magnesium alloy waste material. Typically, a refining process with or without a flux is used to remove impurities from magnesium alloy waste material and then the waste material is casted into new magnesium alloy ingots (Wang Xiao-ming, et al., Research and Development of Recycling Technology and Equipment for Die-Cast Magnesium Alloy High-Risk Waste [J], Special Casting & Nonferrous Alloys, 2011, 31(12): 1127-1131).

It can be known from table A that, the discarded magnesium alloy product is an important source of magnesium alloy waste material which include cars' wheel hubs, steering wheels, engine cylinder caps, airplane bodies, airplane skin, computer casing and camera casing, summing more than 200,000 tons/year. While this kind of waste material has good quality, in the products' manufacturing and/or use, greasiness, dirt and oxide layers can accumulate on its surface, making the treatment challenging. In China, this part of waste material is used to produce consumables and non-conforming magnesium alloy ingots, such as firework coloring agents, desulfurizers and non-standard ingots. However, this approach is actually degraded use of magnesium alloy waste material where the waste material becomes unrecoverable. This not only reduces product value, but also terribly wastes magnesium resources by preventing magnesium from effective and valuable recycling.

GB-standard magnesium alloy ingots form an important source of feedstock for producing magnesium alloy castings. The most extensively used process for producing GB-standard magnesium alloy ingots nowadays involves using pure magnesium and required alloy elements as feedstock, and melting, refining, and alloying the feedstock so as to obtain magnesium alloy liquid compositionally satisfying the requirements set forth in GB standards, and then casting the magnesium alloy liquid into ingots. The known process is demanding in purity and compositions of pure magnesium and alloy materials. Since pure magnesium ingots and alloy materials are expensive, the production costs for preparing GB-standard magnesium alloy ingots significantly increase.

Now that discarded magnesium alloy castings are good in quality, and the only limit to their recycling is technical failure in removing greasiness, dirt, and oxide layers from their surfaces, if there is a competent pretreatment process capable of removing impurities from waste material, theoretically and compositionally the discarded magnesium alloy castings can be used as material for producing GB-standard magnesium alloy ingots. Energy required by re-melting magnesium alloy waste material and making it into GB-standard magnesium alloy ingots is only about 3 KWh/kg, which is one order of magnitude lower than that required by producing GB-standard magnesium alloy ingots from raw material, helping to conserve energy. China Patent No. CN 101736160B discloses a method for recovering magnesium alloy low-level waste. The method involves mechanical cutting, repeated pickling, water rinse, smelting in a resistance furnace, refining, and casting ingots to make magnesium alloy low-level waste material ingots. However, the product's chemical composition is merely close to the compositional quality indicator for magnesium alloy ingots and its mechanical properties are merely close to measurements of magnesium alloy ingots, making its application scope limited. China Patent No. CN101338378A teaches a process for obtaining magnesium alloy ingot by remelting and casting waste magnesium alloy parts. The prior-art method uses 3 to 5 mm steel beads to mechanically grind waste material for 30 to 40 min. However, for waste material of irregular shapes, the grinding effects are not uniform and particularly poor at grooves on waste material surface, with the convex subjecting to serious wear. Besides, a large quantity of magnesium alloy powder can occur during bead blasting, and impact of steel beads forms another concern. The method involves no alloying in the process of re-melting and casting ingots, making it difficult to obtain magnesium alloy ingots meeting the requirements set forth in GB standards.

The reason why there has not been an effective method or process that produces GB-standard magnesium alloy ingots using discarded magnesium alloy products as feedstock is that discarded magnesium alloy products usually come with too many surface impurities because the existing pretreatment is not effective enough. As it is so difficult to fully use discarded magnesium alloy products as feedstock for producing GB-standard magnesium alloy ingots, there has not been any relevant technical disclosure. Presently, the dominant technology for producing GB-standard magnesium alloy ingots is still one involving adding alloy elements to high-purity magnesium, and only a few manufacturers add a little highly pure magnesium alloy casting scraps and non-conforming castings when producing magnesium alloy, and the adding ratio is below 20%, being less helpful to relieve the heavy load of recycling the mass magnesium alloy waste material. Hence, there is a need for a practical method that produces GB-standard magnesium alloy ingots purely from magnesium alloy waste material, particularly from discarded magnesium alloy products.

### SUMMARY OF THE INVENTION

In view of the shortcomings of the prior art, one objective of the present invention is to provide a method for producing GB-standard magnesium alloy ingots. The method directly adopts discarded magnesium alloy products as feedstock for producing GB-standard magnesium alloy ingots, without adding expensive high-purity magnesium, and only needs a small amount of other alloy materials.

For achieving the foregoing objective, the present invention implements the following technical schemes:

A method for producing GB-standard magnesium alloy ingots totally from magnesium alloy waste material comprises the following steps:

Step a. sorting, removing impurities from, cleaning and drying the magnesium alloy waste material, wherein the cleaning includes high-pressure cleaning, pickling, and water rinse performed in sequence;

Step b. preheating the magnesium alloy waste material obtained in Step a, feeding materials, melting, refining, removing impurities from, and alloying the magnesium alloy waste material, so as to obtain magnesium alloy liquid; and

Step c. casting ingots using the magnesium alloy liquid obtained in Step b, so as to obtain GB-standard magnesium alloy ingots.

Preferably, the magnesium alloy waste material is selected from waste magnesium alloy castings as defined in the draft of international classification standards for magnesium and magnesium alloy waste material.

Preferably, Step b or Step c is performed without oxygen or with little oxygen. The operating environment is preferably filled with noble gas, and more preferably N₂ or SO₂.

Since some discarded magnesium alloy products are bulky and irregular in shape, there are many screws and rubber parts inseparable even through sorting and cleaning. Besides, large magnesium alloy scraps are usually hollow, leading to low packing density. Thus, the magnesium alloy waste material in Step a is preferably cut before sorted and having impurities removed therefrom.

Preferably, in Step a, the high-pressure cleaning is performed under a pressure of 5 to 20 MPa, and more preferably 10 to 15 MPa.

More preferably, Step a involves cutting, sorting, removing impurities from, high-pressure cleaning, pickling, water rinse and drying the magnesium alloy waste material, wherein it can be divided into the following steps:

Step a1: cutting each large piece of the magnesium alloy waste material into plural small pieces of the magnesium alloy waste material, so as to separate magnesium alloy material containing screws and rubber, and to meet the feedstock size requirements of the subsequent processing equipment;

Step a2: sorting and removing impurities from the cut magnesium alloy waste material pieces, so as to screen out impurities that are difficult to separate from the magnesium alloy waste material;

Step a3: high-pressure cleaning the magnesium alloy waste material that has been sorted and has impurities removed, so as to remove surface dust, greasiness, dirt or loose oxide layer from the magnesium alloy waste material;

Step a4: pickling the magnesium alloy waste material that has been high-pressure cleaned;

Step a5: water rinsing the magnesium alloy waste material that has been pickled; and

Step a6: drying the magnesium alloy waste material that has been water rinsed.

More preferably, Step a further comprises Step a7: sorting the dried magnesium alloy waste material again so as to obtain clean waste material. Therein, clean waste material is defined as: magnesium alloy waste material whose contents of harmful elements are allowed by GB standards. Therein, a harmful element refers to any element that can significantly decrease some properties of magnesium alloy (including corrosion resistance, mechanical properties, etc.) even when existing in a minimum amount, such as Si, Cu, Ni, and Fe.

More preferably, Step a1 involves: cutting the magnesium alloy waste material with a metal crusher, so that each piece of the cut magnesium alloy waste material is smaller than 300 mm in all dimensions, preferably 50 to 300 mm, and more preferably 100 mm, depending on the size of the magnesium alloy waste material to be processed and on the equipment.

More preferably, Step a2 involves: screening waste with inseparable screws, rubber, or plastic, waste with organic surface coating, and non-magnesium waste out of the magnesium alloy waste material obtained in Step a1. In other words, magnesium alloy waste material containing screws, rubber and plastic are separated out, and the remaining magnesium alloy waste material is reserved for later use.

More preferably, Step a3 involves: placing the magnesium alloy waste material obtained in Step a2 in a material-holding device, and high-pressure cleaning the magnesium alloy waste material in the material-holding device using a high-pressure cleaning machine. Therein, a material-holding device is defined as a device that holds the magnesium alloy waste material in a certain range and allows the waste material to randomly roll in that range. It not only prevents the waste material from flushed away by the high-pressure water, but also ensures that the waste material is cleaned thoroughly and evenly.

Furthermore, the material holding for the high-pressure cleaning is preferably realized using a meshed (hollowed-out) drum or other known material-holding methods, depending on the conditions of where the present invention is implemented. Therein, the meshed drum has its mesh diameter smaller than 50 mm. As long as the drum is strong enough to bear the impact pressure from the high-pressure water, the mesh number in a unit area of the drum can be maximized. The actual number may be adjusted according to the drum material, the pressure for high-pressure cleaning or the mesh diameter, so as to ensure its cleaning effect by draining the aqueous solution as a product of the high-pressure cleaning timely and thereby allowing the cleaning liquid to impact the waste material directly.

As a preferred scheme, the material-holding device is an electric meshed drum, wherein the meshed drum is electrically driven to rotate, so that the magnesium alloy waste material randomly rolls as the meshed drum rotates.

More preferably, in the process of cleaning magnesium alloy waste material with high-pressure water, particularly in the process of removing impurities from grooves of the magnesium alloy waste material, the impact caused by the water is greater than the adhesion between the impurities and the magnesium alloy waste material surface, and thus the bubbles generated by strong water pressure are capable of peeling and flushing away normal impurities. So the high-pressure cleaning is a primary high-pressure cleaning. However, during cleaning, where the magnesium alloy waste material to be treated has its surfaces covered by greasiness or demolding agents, there may be a thick, sticky mixed impurity layer of greasiness and dirt formed thereon. While the high-pressure water can somehow remove the mixed impurity layer using its pressure, the fact that water and oil are not miscible with each other makes it difficult to fully clean the greasiness or demolding agents adhering to surface of the magnesium alloy waste material without adding any cleaning agent that capable of purging greasiness and demolding agents. Hence, the inventor of the present invention divides high-pressure cleaning into two stages, namely a primary high-pressure cleaning and a secondary high-pressure cleaning. The primary high-pressure cleaning uses high water pressure to flush impurities away from the surface of the magnesium alloy waste material, and the secondary high-pressure cleaning uses a cleaning agent combined with high-pressure water so as to easily remove greasiness and demolding agents, and further remove dirt and loosened oxide layers.

As another preferred scheme, the cleaning agent is a degreasing agent, whose type and concentration may be decided according to the type and amount of greasiness on the waste material's surface. It is preferably a water-based metal degreasing agent, and more preferably an acid water-base metal degreasing agent. It may additionally or alternatively be other degreasing agents known in the art, such as oil emulsifier or biological decomposer.

Further, the cleaning liquid for high-pressure cleaning is water and/or a cleaning agent and the cleaning liquid has a pH value of 5 to 7.

Further, the cleaning liquid for the primary high-pressure cleaning is water, and the cleaning duration is 10 to 30 min. The cleaning liquid of the secondary high-pressure cleaning is aqueous solution containing a cleaning agent. The cleaning liquid temperature is 40 to 70° C., and the cleaning duration is 5 to 10 min. The actual duration and temperature of the high-pressure cleaning depend on the severity of greasiness.

More preferably, Step a4 involves: placing the magnesium alloy waste material obtained in Step a3 into a pickling bath for pickling, so as to remove oxide layers from the magnesium alloy waste material surface.

Further, the pickling duration is 30 to 90s, and the pickling liquid's pH value is 1 to 3. The pickling liquid is any solution or a mixture of hydrochloric acid, nitric acid, sulfuric acid, and oxalic acid. The actual composition depends on degree of oxidation of the magnesium alloy waste material surface.

Further, the pickling liquid can be reused for several times. For ensuring that the pickling liquid is in a proper pH range, before every time of reuse, some new acid is added so that the pickling liquid's pH value remains at 1 to 3. Where Mg²⁺ concentration in the solution is greater than 2.0 mol/L, the pickling liquid is replaced. The waste acid generated after pickling is then recycled after neutralized, filtered, evaporated for crystallization and dried. In particular, MgO or MgCO₃ is used to neutralize the waste acid so as to increase its pH value to about 7. Then filtration is performed to remove water, thereby obtaining dry magnesium salts. The obtained dry magnesium salts are of high purity and can be used to prepare magnesium fertilizer.

Still further, the filtration is realized using a press filter.

Still further, water is removed from the filtrate by evaporating, concentrating, filtering, and drying. Other methods for removing water known in the art may be alternatively used, such as vacuum drying, depending on the conditions of where the present invention is implemented.

Still further, the foregoing evaporating, concentrating, filtering, and drying procedures may be realized using a crystallizer and a filter as well as a dryer coming with the crystallizer as a whole suite.

More preferably, Step a5 involves: removing acid liquid and impurities remained on a surface of the magnesium alloy waste material obtained in Step a4 using water, preferably by means of rinsing or spraying. Other methods for water rinse known in the art may be alternatively used, depending on the conditions of where the present invention is implemented.

More preferably, Step a6 involves: removing water remained on a surface of the magnesium alloy waste material obtained in Step a5, preferably by means of air blowing or hot air drying. Other methods for water rinse known in the art may be alternatively used, depending on the conditions of where the present invention is implemented. At this point, the pretreatment for the magnesium alloy waste material is completed. Air blowing is herein defined as an operation that simply uses high-pressure air flow to impact and remove water drops on the surface of the waste material, thereby reducing time and working load of hot air drying. For preventing the waste material from oxidization, use of hot air drying is minimized if not eliminated.

More preferably, Step a7 involves: screening unclean waste material and non-magnesium material from the magnesium alloy waste material obtained in Step a6, so as to obtain clean waste material.

Preferably, Step b comprises preheating, melting, detecting harmful elements for, refining, alloying, skimming slag from and standing aside under a controlled temperature the magnesium alloy waste material obtained in Step a, and is divided into the following steps:

Step b1: preheating the magnesium alloy waste material obtained in Step a, so as to remove moisture that may otherwise lead to explosion and gas inclusion;

Step b2: heating and melting the magnesium alloy waste material obtained in Step b1;

Step b3: detecting contents of harmful elements in the magnesium alloy liquid obtained in Step b2, and determining whether to prepare the GB-standard magnesium alloy ingots according to the contents;

Step b4: refining the magnesium alloy liquid detected in Step b3 for preparing the GB-standard magnesium alloy ingots;

Step b5: alloying the magnesium alloy liquid obtained in Step b4;

Step b6: detecting contents of metal elements in the magnesium alloy liquid obtained in Step b5;

Step b7: analyzing to determine whether the contents of the metal element other than iron as detected in Step b6 conform standards, and proceeding to the next step if yes or repeating Step b5 and Step b6 until they become conforming;

Step b8: skimming slag from the magnesium alloy liquid that has been verified as being conforming in Step b7;

Step b9: standing the magnesium alloy liquid obtained in Step b8 while controlling its temperature; and

Step b10: detecting and analyzing whether a content of iron in the magnesium alloy liquid obtained in Step b9 conforms standard, and entering Step c if yes. It is to be noted that, for lowering costs and saving time, the magnesium alloy liquid can be refined again while alloyed, so as to obtain magnesium alloy liquid with higher purity.

More preferably, in Step b6, the metal elements in the magnesium alloy liquid are checked for conformity with casted magnesium alloy ingots of GB/T 19078-2003.

More preferably, Step b1 involves: placing the clean waste material in to an oven and discharging moisture generated during evaporation using an air-extracting device.

Further, in Step b1, the preheating temperature is 120 to 150° C.

Further, in Step b1, the preheating duration is 5 to 20 min.

More preferably, Step b2 involves: adding the preheated magnesium alloy waste material into a smelting furnace in batches, while throwing in a flux (60-100 kg/tons) for covering and extinguishing fire.

Further, the furnace temperature in the smelting furnace is 850-950° C.

Further, the flux is an alloy flux known in the art, such as Fluxing Agent No. 2, which is selected according to practical needs for production of magnesium alloy ingots. The present invention places no limitation thereto.

As a preferred scheme, in order to minimizing scaling loss of the magnesium alloy waste material in the smelting furnace, the magnesium alloy waste material may be introduced into the smelting furnace in batches. The first batch of the added magnesium alloy waste material is about ⅓ to ¼ of the total capacity of the smelting furnace, and each subsequent batch is about ¼ to ⅕ of the total capacity of the smelting furnace, until the smelting furnace is fully loaded. The smelting furnace is such selected that its total capacity meets the need for production of GB-standard magnesium alloy ingots, and preferably 1t, 2t or 3t. After each batch is added, a layer of flux should by scattered on the surface of the magnesium alloy waste material evenly, so as to prevent combustion of magnesium alloy under high temperature.

More preferably, Step b4 is optionally performed depending on GB-standard magnesium alloy ingots to be produced and on the analysis results of elements done in Step b3, so as to obtain alloying products of different models. In other words, if the contents detected in Step b3 conform to the content requirements for these harmful elements as set forth in GB standards, the melt is used to produce GB-standard magnesium alloy ingots. Otherwise, it may be used to produce non-standard magnesium alloy ingots. The method of the present invention can directly produce AZ91D GB-standard magnesium alloy ingots from magnesium alloy waste material. In addition, for producing GB-standard magnesium alloy ingots of other designations, such as AM50A/AM60B, pure magnesium may be added to properly dilute the main elements so as to make the contents conform standards. The adding amount of pure magnesium may be decided according to specific designations.

More preferably, Step b4 involves: sending the magnesium alloy waste material that has been melted to a smelting furnace, adding a refining agent evenly, performing agitation, and blanketing with the refining agent for extinguishing fire while agitation.

More preferably, Step b5 involves: sampling and analyzing the magnesium alloy liquid obtained in Step b4, determining adding amounts of alloy elements according to analysis, adding alloy material to the magnesium alloy liquid obtained in Step b4, adding a refining agent evenly as the alloy material is melted, performing agitation, and blanketing with the refining agent for extinguishing fire while agitation. In other words, alloying and a second-time refining are performed at the same time.

Further, in Step b4 or b5, the refining agent is added evenly, preferably in a small amount for multiple times, and a total adding amount thereof is 15 to 25 kg/t, and the refining duration is 15 to 30 min. The agitation is mechanical agitation and/or gas blowing. The agitation is performed throughout the refining.

Further, during agitation, nitrogen gas is used together with the agitating machine for all-direction agitation.

Further, in Step b4, the refining temperature is 710 to 730° C.

Further, in Step b5, the refining temperature is 720 to 740° C.

Further, the refining agent for refining is any refining agent for alloy refining as known in the art, such as a composite flux made of Fluxing Agent No. 2 and fluorspar powder, wherein the fluorspar powder takes 10% to 25%, depending on the practical needs for production of magnesium alloy ingots, and the present invention places no limitation thereto.

More preferably, in Step b5, criteria for metal elements for alloying are:

Mg: magnesium ingots of Grade 1 or better;

Al: aluminum ingots of Grade 1 or better;

Zn: zinc ingots of Grade 1 or better;

Mn: one of high-purity Al—Mn alloy, metal manganese powder with its purity greater than 99.8%, and anhydrous manganese chloride with its purity greater than 99.8%;

Be: high-purity Al—Be alloy.

Further, element Be tends to be oxidized and vaporize. For minimizing loss, it is usually added late in the refining process.

Further, the order for alloy materials to be added is Mn, Al and Zn, Mg (up to the practical needs to add it or not), and Be in sequence. It is to be noted that it is not a fixed order, and each of the five alloy elements is only added in such order when its addition is needed. For example, when there is no need to add Mg, the order for adding alloy elements is Mn, Al, Zn, and Be.

More preferably, Step b8 involves: using a skimming pack to skimming slag from the alloyed/re-refined magnesium alloy liquid, and using dry nitrogen gas to blow, thereby lifting magnesium slag precipitated at the bottom of the smelting furnace and letting the magnesium slag naturally fall into the skimming ladle while sinking. Since magnesium slag has its density relatively high, it will expel magnesium liquid from the skimming ladle gradually, thereby achieving slag skimming.

More preferably, Step b9 involves: setting the magnesium alloy liquid obtained in Step b8 aside under controlled temperature. In particular, the magnesium alloy liquid obtained in Step b8 is firstly cooled and then heated by means of a temperature controlling method known in the art, such as blowing cold air into the furnace or adding a proper amount of GB-standard magnesium alloy ingots to decrease the temperature to 640±5° C., and then immediately increase the temperature to 660 to 670° C., so as to remove the Fe component from the magnesium alloy liquid.

Further, the duration for setting the liquid aside is 40 min.

Further, in Step b9, the time required is the longer one of the duration for liquid settling and the duration for temperature controlling.

More preferably, in Step b6 or Step b10, spectral analysis with an atomic emission spectrometer or other known methods and instruments for alloy detection may be used, without limitation.

More preferably, the conforming magnesium alloy liquid as verified in Step b10 is reserved for later use, or transferred to the temperature-holding furnace wherein sulphur powder or mixed gas of SO₂ and N₂ is used for protection. A covering agent is used to protect the magnesium alloy liquid that is not fully transferred so as to further setting the magnesium alloy liquid aside for facilitating the subsequent ingot casting operation.

Further, the temperature is held at 640 to 670° C.

As a preferred scheme, a liquid-transferring pump or a liquid-transferring pack is used to transfer the magnesium alloy liquid, wherein the liquid-transferring pump and the liquid-transferring tube or the liquid-transferring pack is preheated before use. More preferably, Step c comprises the following steps:

Step c1: preheating an ingot mold, and applying an even layer of demolding paint over an inner surface of the ingot mold;

Step c2: preheating a casting pump and a casting pipeline; and Step c3: connecting the casting pump and the pipeline, starting a casting machine to perform casting.

More preferably, the casted magnesium alloy ingots are cooled evenly so as to prevent segregation.

More preferably, preheating temperature is 150 to 220° C.; pouring temperature is 660 to 670° C.

More preferably, Step c further comprises Step c4: performing post-treatment on the magnesium alloy ingots obtained in Step c3, including burnishing, printing codes on and packing the magnesium alloy ingots.

As compared to the prior art, the present invention has the following advantages: (1) The disclosed method uses magnesium alloy waste material directly as feedstock, and is particularly suitable for purely using discarded magnesium alloy products as feedstock for producing GB-standard magnesium alloy ingots, thus providing high use value and significantly lowering production costs;

(2) The disclosed pretreatment process has excellent cleaning and impurity-removing effects, and its smelting method is advanced and reasonable, and by combining the two, the present invention successfully allows GB-standard magnesium alloy ingots to be purely made from magnesium alloy waste material, without adding expensive high-purity magnesium;

(3) The acid liquid used for pretreatment can be recycled and reused, and the generated waste acid can be further used to produce high-purity magnesium salt as feedstock for making magnesium fertilizer, thereby achieving zero discharge of waste pickling liquid, and being economic and environmentally friendly;

(4) Since magnesium alloy waste material contains a certain level of alloy elements, only a small amount of alloy elements is required for alloying to obtain the conforming magnesium alloy liquid, so the addition of alloy elements are significantly reduced thereby lowering production costs;

(5) The magnesium slag generated from refinement can be subjected to a decontamination process as disclosed in a previous research of the inventor of the present invention (Patent Application No.: PCT/CN2014/075237), so as to obtain high-purity magnesium oxide, thereby minimizing contamination to the environment, facilitating efficient recycling of three kinds of waste, answering to the needs of conserving energy and reducing emission, and in turn bringing about great economic benefits and environmental benefits;

(6) The energy consumption is relatively low because energy consumed by making magnesium alloy ingots through recycling and remelting magnesium alloy waste material is less than 10% of that required by producing a batch of brand new magnesium alloy ingots; (7) The entire process is easy to realize, and its operation is relatively simple, while conserving energy, protecting the environment, and being suitable for industrialization.

### DETAILED DESCRIPTION OF THE INVENTION

The invention as well as a preferred mode of use, further objectives and advantages thereof will be best understood by reference to the following detailed description of illustrative, non-limiting embodiments.

In the following examples, the reagents used are all commercially available ones, unless otherwise specified, and are used according to their instructions or relevant standards. In addition, the flux(es) and refining agent(s) used in the following examples are products of Binhai Heng Wang Light Metal Flux Co., Ltd.

### Example 1

The present example uses discarded magnesium alloy products imported by Hunan S.R.M. Technology CO., Ltd. from Sweden with a batch number of 2013-10-05-A as the feedstock for producing AZ91D magnesium alloy ingots. The batch of magnesium alloy waste material sums 5000 tons. Waste having its surface carrying greasiness and demolding agents takes about 10% of the entire batch. The producing steps are as follows:

(1) Cutting: cutting the magnesium alloy waste material using a metal crusher to waste pieces whose maximum dimension is 100 mm;

(2) Sorting and removing impurities: screen waste material containing inseparable screws, rubber or plastic, waste material with its surface covered by organic coating, and non-magnesium material out from the cut magnesium alloy waste material, and reserving the remaining magnesium alloy waste material for later use;

(3) Primary high-pressure cleaning: performing primary high-pressure cleaning on the magnesium alloy waste material that has been sorted and has impurities removed using a heavy-duty hot-water high-pressure cleaning machine modeled 895-1, wherein the cleaning liquid is water, the pressure is 10 MPa, and the cleaning duration is 20 min;

(4) Secondary high-pressure cleaning: performing secondary high-pressure cleaning on the magnesium alloy waste material that have received the primary high-pressure cleaning using the heavy-duty hot-water high-pressure cleaning machine modeled 895-1, wherein the cleaning liquid is aqueous solution containing an acid water-based metal degreasing agent, in which the aqueous solution prepared according to its formula has a pH value of 5.5, and for the cleaning, the aqueous solution temperature is 55° C., the pressure is 10 MPa, and the cleaning duration is 10 min;

(5) Pickling: placing the magnesium alloy waste material that has received the secondary high-pressure cleaning into dilute hydrochloric acid solution having a pH value of 1.0 for pickling, wherein the pickling duration is 40 s;

(6) Water rinsing: combining rinsing and spraying to remove acid liquid and impurities remained on the surface of the obtained magnesium alloy waste material;

(7) Drying: combining air blowing and hot air drying to remove water remained on the surface of the cleaned magnesium alloy waste material;

(8) Sorting again: sorting unclean waste material and non-magnesium material out of the dried waste material, thereby finalizing pretreatment for the magnesium alloy waste material;

(9) Preheating: placing the sorted, clean waste material into an oven, preheating it for 10 min to 130° C., and exhausting evaporated moisture through an air-extracting device;

(10) Heating and melting: adding the preheated magnesium alloy waste material in batches into a high-temperature smelting furnace, while gradually adding 8% of a flux for covering and extinguishing fire, wherein the furnace temperature is 850-950° C.;

(11) Refining: throwing a refining agent in batches evenly, performing mechanical agitation and air-blowing agitation while using the refining agent to cover and extinguish fire, wherein the refining duration is 20 min, and the refining temperature is 720° C.;

(12) Sampling and analyzing: subjecting the obtained magnesium alloy liquid to sampling (recorded as Sample #1) and spectral analysis, determining whether harmful elements (such as Si, Cu, Ni) exceed limits according to the analysis, and if the contents are seriously excessed, directly casting non-standard magnesium alloy ingots, or if the contents are slightly excessed, using pure magnesium dilution to reducing the exceeding elements to a conforming range, or if the contents are conforming, determining adding amounts of different elements (such as Al, Zn, Mn) for alloying according to the analysis, wherein the detected harmful elements and the adding amount of the other metal elements for the present example are shown in Table 1.1:

TABLE 1.1
Results of Spectral Detection for Sample #1

| | Element | | | | | | | | |
|---|---|---|---|---|---|---|---|---|---|
| | Al | Zn | Mn | Si | Fe | Cu | Ni | Be | Mg |
| Content (%) | 6.89 | 0.345 | 0.187 | 0.039 | 0.007 | 0.0072 | 0.0005 | 0.0003 | Residue |

As shown clearly in Table 1.1, the harmful elements Si, Cu, and Ni are all in limits set forth in GB standards, and the material could be directly subjected to the subsequent alloying/refining operation. According to Table 1.1, the calculated adding amounts for the alloy elements Al, Zn, Mn, and Be are shown in Table 1.2:

TABLE 1.2
Required Adding amount of Alloy Elements for Alloying

| | | | | Al—Be Containing |
|---|---|---|---|---|
| Required Element | Al | Zn | Mn | 1.0% Beryllium |
| Total adding | 65.0 kg | 9.5 kg | 4.0 kg | 4.5 kg |
| amount | | | | |

Note:
At sampling, the magnesium alloy liquid's weight is 2,950 kg.

(13) Alloying/Refining: according to Table 2, adding all the alloy materials in sequence, evenly adding 2% of a refining agent while melting the alloy materials, and performing mechanical agitation and gas-blowing agitation, covering and extinguishing fire with the refining agent while agitating, wherein the alloying/refining duration is 15 min, and the temperature is 740° C.;

(14) Sampling and analyzing: performing spectral sampling and analysis on the magnesium alloy liquid obtained in the previous step (recorded as Sample #2), and subjecting it to the subsequent processing if conforming, or performing alloying/refining again if the obtained magnesium alloy liquid is non-conforming. The results of the analysis are shown in Table 1.3:

TABLE 1.3
Results of Spectral Detection for Sample #2

| | Element | | | | | | | | |
|---|---|---|---|---|---|---|---|---|---|
| | Al | Zn | Mn | Si | Fe | Cu | Ni | Be | Mg |
| Content (%) | 9.01 | 0.632 | 0.321 | 0.040 | 0.006 | 0.0073 | 0.0005 | 0.0014 | Residue |

As can be seen in Table 1.3, the magnesium alloy liquid has all the alloy elements other than Fe measured as conforming, thus needing not to be alloyed/refined again;

(15) Skimming slag: placing the fully preheated skimming ladle into the magnesium alloy liquid slowly, until it sunk to the bottom of the smelting furnace, and blowing up magnesium slag from the bottom using dry N₂, wherein since magnesium slag is greater than magnesium alloy liquid in specific weight, magnesium slag would settle in the skimming ladle, thereby achieving slag skimming;

(16) Setting aside under controlled temperature: before setting aside, adding a proper amount of GB standards alloy ingots according to the magnesium liquid's temperature, cooling the magnesium liquid to 640±5° C., then immediately heating it to 660 to 670° C., and setting the magnesium alloy liquid aside, wherein the duration for setting aside is more than 40 min;

(17) Sampling, analyzing and subsequent processing: sampling the settled magnesium alloy liquid (recorded as Sample #3) for analysis; if the magnesium alloy liquid conforms standard, directly using the settled magnesium alloy liquid for casting ingots according to actual production conditions, or transferring the settled magnesium alloy liquid to a temperature-holding furnace; if not conforming, adding a proper amount of alloy materials as needed, and then casting ingots or performing liquid transferring operation, wherein for liquid transferring, sulphur powder is used for fire-extinguishing of the magnesium alloy liquid remained in the smelting furnace, and the remaining magnesium alloy liquid is protected using a covering agent, while noble gas is used in the temperature-holding furnace for protection, wherein the results of detection and analysis are shown in Table 1.4:

TABLE 1.4
Results of Spectral Detection for Sample #3

| | Element | | | | | | | | |
|---|---|---|---|---|---|---|---|---|---|
| | Al | Zn | Mn | Si | Fe | Cu | Ni | Be | Mg |
| Content (%) | 8.98 | 0.629 | 0.250 | 0.039 | 0.003 | 0.0070 | 0.0005 | 0.0012 | Residue |

As can be seen in Table 1.4, alloy elements measured in the magnesium alloy are all conforming to GB standards, and the subsequent liquid transferring and ingot casting operations could be performed;

(18) Pretreatment on ingot mold: preheating an ingot mold to 180° C., and applying a layer of demolding paint evenly to the ingot mold's inner surface;

(19) Pouring: preheating and connecting the casting pump and the casting pipeline, and starting the casting machine to perform casting; and

(20) Post-treatment: performing post-treatment such as burnishing, printing codes on and packing the casted magnesium alloy ingots.

As measured, the magnesium alloy ingots made in the present example are compositionally conforming to Chinese national standards, wherein chloride ion content is 0.0010%, and there is only little flux mixture. In addition, as measured form Sample #1, in the magnesium alloy liquid of the present example, harmful elements conforming casts take 98% in total casts, and slightly non-conforming casts take 2%, without any seriously non-conforming casts.

### Example 2

The present example is different from Example 1 in the contents of harmful elements measured in Step 12 after refinement in Step 11. The results are shown in Table 2.1:

TABLE 2.1
Results of Spectral Analysis for Refined Magnesium Alloy Liquid

| | Element | | | | | | | | |
|---|---|---|---|---|---|---|---|---|---|
| | Al | Zn | Mn | Si | Fe | Cu | Ni | Be | Mg |
| Content (%) | 7.12 | 0.321 | 0.201 | 0.053 | 0.008 | 0.0079 | 0.0007 | 0.0003 | Residue |

Note:
At sampling, the magnesium alloy liquid's weight is 2,550 kg.

It is thus clear from Table 2.1 that the content of the harmful element Si is slightly excessed, and thus brings the need of adding pure magnesium to reduce silicon. As determined using calculation, the required adding amount of pure magnesium is 400 kg. After pure magnesium is added, the melt is agitated thoroughly before sampled again for harmful element analysis. The results are shown in Table 2.2:

TABLE 2.2
Results of Spectral Analysis of Magnesium Alloy Liquid after Addition of Pure
Magnesium

| | Element | | | | | | | | |
|---|---|---|---|---|---|---|---|---|---|
| | Al | Zn | Mn | Si | Fe | Cu | Ni | Be | Mg |
| Content (%) | 6.21 | 0.280 | 0.178 | 0.046 | 0.008 | 0.0081 | 0.0008 | 0.0002 | Residue |

It is thus clear from Table 2.2 that the content of the harmful element Si is 0.046%, conforming to Chinese national standards, so the melt could be put into the subsequent alloying/refining operation directly.

Given the addition of pure magnesium, the amount of the alloy materials added for subsequent alloying is adjusted, but the rest part of the operation is identical to Example. The required adding amount of alloy elements for alloying is calculated according to Table 2.1 and 2.2. The results are shown in Table 2.3:

Table 2.3 Required Adding amount of Alloy Elements for Alloying:

TABLE 2.3
Required Adding amount of Alloy Elements for Alloying

| | | | | Al—Be Containing |
|---|---|---|---|---|
| Required Element | Al | Zn | Mn | 1.0% beryllium |
| Total adding | 84.0 kg | 11.0 kg | 5.0 kg | 5.0 kg |
| amount | | | | |

The contents of alloy elements subsequently measured in the magnesium alloy liquid are shown in Table 2.4:

TABLE 2.4
Results of Spectral Detection for Sample #2

| | Element | | | | | | | | |
|---|---|---|---|---|---|---|---|---|---|
| | Al | Zn | Mn | Si | Fe | Cu | Ni | Be | Mg |
| Content (%) | 8.96 | 0.638 | 0.310 | 0.045 | 0.006 | 0.0079 | 0.0007 | 0.0013 | Residue |

As can be seen in Table 2.4, the magnesium alloy liquid is conforming, with the contents of all the alloy elements other than Fe within the limits as set forth in GB standards, and thus it could receive the subsequent processing.

As measured, the magnesium alloy ingots made in the present example are compositionally conforming to Chinese national standards, wherein chloride ion content is 0.0010%, and there is only little flux mixture. In addition, as measured form Sample #2, in the magnesium alloy liquid of the present example, harmful elements conforming casts take 98% in total casts, and slightly non-conforming casts take 2%, without any seriously non-conforming casts.

### Example 3

The present example is different from Example 1 in that its target magnesium alloy ingots are AM60B. Since the target magnesium alloy ingots are different, the alloy elements needed to be added are different.

According to results of the spectral analysis of Step 12, the subsequent operations are adjusted. Results of the spectral analysis are shown in Table 3.1

TABLE 3.1
Results of Spectral Analysis

| | Element | | | | | | | | |
|---|---|---|---|---|---|---|---|---|---|
| | Al | Zn | Mn | Si | Fe | Cu | Ni | Be | Mg |
| Content (%) | 6.98 | 0.332 | 0.198 | 0.038 | 0.008 | 0.0069 | 0.0007 | 0.0003 | Residue |

Note:
At sampling, the magnesium alloy liquid's weight is about 1,650 kg.

As can be seen in Table 3.1, among the main elements, the contents of aluminum and zinc content are excessed, with the content of zinc significantly exceeding the limit. This brings about the need of adding pure magnesium to reduce zinc and the need of supplementing aluminum, manganese and beryllium as well. As calculated, the type and weight of the elements added are shown in Table 3.2:

TABLE 3.2
Type and Weight of Elements Added for Alloying

| Added | Pure | Aluminum | Manganese | 1.0% Aluminum |
|---|---|---|---|---|
| material | Magnesium | Ingots | Powder | Beryllium Alloy |
| Adding | 1300 | 60 | 7.0 | 5.0 |
| amount | | | | |
| (kg) | | | | |

The element materials are added according to Table 3.2. After fully agitation, the magnesium alloy liquid is sampled again for spectral analysis. Results of the analysis are shown in Table 3.3:

TABLE 3.3
Results of Spectral Analysis after Elements Added

| | Element | | | | | | | | |
|---|---|---|---|---|---|---|---|---|---|
| | Al | Zn | Mn | Si | Fe | Cu | Ni | Be | Mg |
| Content (%) | 5.96 | 0.188 | 0.385 | 0.025 | 0.008 | 0.0075 | 0.0008 | 0.0015 | Residue |

As can be seen in Table 3.3, the magnesium alloy liquid is conforming, with the contents of all the alloy elements other than Fe within the limits as set forth in GB standards, and thus it could receive the subsequent processing.

As measured, the magnesium alloy ingots made in the present example are compositionally conforming to Chinese national standards, wherein chloride ion content is 0.0010%, and there is only little flux mixture. In addition, as measured form Sample #3, in the magnesium alloy liquid of the present example, harmful elements conforming casts take 98% in total casts, and slightly non-conforming casts take 2%, without any seriously non-conforming casts.

### Comparative Example 1

The present comparative example is similar to Example 1 except that it eliminates the foregoing pretreatment. The magnesium alloy liquid obtained after the melting and refining steps is sampled for spectral analysis and the results are shown in the table below:

TABLE a
Results of Spectral Analysis of Magnesium Alloy Liquid Obtained without Pretreatment

| | Element | | | | | | | | |
|---|---|---|---|---|---|---|---|---|---|
| | Al | Zn | Mn | Si | Fe | Cu | Ni | Be | Mg |
| Content (%) | 7.56 | 0.452 | 0.286 | 0.326 | 0.025 | 0.152 | 0.052 | 0.0004 | Residue |

It is thus clear from Table a that harmful elements Si, Fe, Cu, and Ni are seriously excessed, so the material fails to meet the requirements for producing GB-standard magnesium alloy ingots in an industrialized process, and could be only used to produce non-standard magnesium alloy ingots.

### Comparative Example 2

The traditional process is used to produce AZ91D magnesium alloy ingots same as those made in Example 1, and alloy materials added for alloying are shown in Table b below:

TABLE b
Type and Weight of Elements Added for Alloying

| | | | | Al—Be Containing |
|---|---|---|---|---|
| Required Element | Al | Zn | Mn | 1.0% beryllium |
| Total adding | 270 kg | 19.5 kg | 9.0 kg | 5.0 kg |
| amount | | | | |

As can be seen in Table b, using the traditional method to produce the magnesium alloy ingots as those produced in Example 1 requires pure magnesium as feedstock, and the required adding amounts of alloy elements are much higher than those for the present invention. It is thus clear that the method for producing magnesium alloy ingots as disclosed herein requires less input and lower costs and is favorable to material cycles, energy conservation and environmental protection.

From the aforementioned experimental results, it is clear that the disclosed method produces GB-standard magnesium alloy ingots by directly using magnesium alloy waste material as feedstock. The disclosed method features that GB-standard magnesium alloy ingots can be produced purely with discarded magnesium alloy products as its feedstock, without adding expensive high-purity magnesium. In production, conforming casts take 98% in total casts in terms of harmful element, and slightly non-conforming casts take 2%, without any seriously non-conforming casts. Additionally, as compared to the existing methods, the disclosed method is advantageous for needing less alloy elements addition, consuming much less energy, having higher use value, significantly reducing production costs, being easy to implement, involving simple operation, and being suitable for industrialization, and thus shows significant advancement.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for producing GB-standard magnesium alloy ingots from magnesium alloy waste material, comprising the following steps:
Step a. sorting, removing impurities from, cleaning and drying the magnesium alloy waste material, wherein the cleaning involves high-pressure cleaning, pickling, and water rinse performed in sequence;
Step b. preheating, melting, refining, removing impurities from, and alloying the magnesium alloy waste material obtained in Step a, so as to obtain magnesium alloy liquid; and
Step c. casting ingots using the magnesium alloy liquid obtained in Step b, so as to obtain GB-standard magnesium alloy ingots.

2. The method of claim 1, wherein in Step a, the high-pressure cleaning is performed under a pressure of 5 to 20 MPa.

3. The method of claim 1, wherein Step a involves cutting, sorting and removing impurities from, high-pressure cleaning, pickling, water rinse and drying the magnesium alloy waste material, and is divided into the following steps:
Step a1: cutting each large piece of the magnesium alloy waste material into plural small pieces of the magnesium alloy waste material;
Step a2: sorting and removing impurities from the cut magnesium alloy waste material pieces, so as to screen out impurities that are difficult to separate from the magnesium alloy waste material;
Step a3: high-pressure cleaning the magnesium alloy waste material that has been sorted and has impurities removed;
Step a4: pickling the magnesium alloy waste material that has been high-pressure cleaned;
Step a5: water rinsing the magnesium alloy waste material that has been pickled; and
Step a6: drying the magnesium alloy waste material that has been water rinsed.

4. The method of claim 3, wherein material holding for the high-pressure cleaning is realized using a meshed drum.

5. The method of claim 1, wherein the high-pressure cleaning is a primary high-pressure cleaning, or wherein where the magnesium alloy waste material has its surface covered by greasiness or demolding agents, the high-pressure cleaning includes a primary high-pressure cleaning and a secondary high-pressure cleaning.

6. The method of claim 1, wherein a cleaning agent for the high-pressure cleaning is a degreasing agent.

7. The method of claim 1, wherein a cleaning liquid for the high-pressure cleaning is water and/or a cleaning agent.

8. The method of claim 7, wherein a cleaning liquid for the primary high-pressure cleaning is water.

9. The method of claim 7, wherein a cleaning duration for the primary high-pressure cleaning is 10 to 30 min.

10. The method of claim 7, wherein a cleaning liquid for the secondary high-pressure cleaning is an aqueous solution containing a cleaning agent.

11. The method of claim 7, wherein a cleaning liquid for the secondary high-pressure cleaning has a temperature of 40 to 70° C.

12. The method of claim 7, wherein a cleaning duration for the secondary high-pressure cleaning is 5 to 10 min.

13. The method of claim 3, wherein Step a4 involves: a pickling liquid for the pickling has a pH value of 1 to 3, and a pickling duration for the pickling is 30 to 90 s.

14. The method of claim 1, wherein Step b comprises preheating, melting, detecting harmful elements for, refining, alloying, skimming slag from and setting aside under a controlled temperature the magnesium alloy waste material obtained in Step a, and is divided into the following steps:
Step b1: preheating the magnesium alloy waste material obtained in Step a;
Step b2: heating and melting the magnesium alloy waste material obtained in Step b1;
Step b3: detecting contents of harmful elements in the magnesium alloy liquid obtained in Step b2, and determining whether to prepare the GB-standard magnesium alloy ingots according to the contents;
Step b4: refining the magnesium alloy liquid detected in Step b3 for preparing the GB-standard magnesium alloy ingots;
Step b5: alloying the magnesium alloy liquid obtained in Step b4;
Step b6: detecting contents of metal elements in the magnesium alloy liquid obtained in Step b5;
Step b7: analyzing to determine whether the contents of the metal element other than iron as detected in Step b6 are conforming, and proceeding to the next step if yes or, if not, repeating Step b5 and Step b6 until they become conforming;
Step b8: skimming slag from the magnesium alloy liquid that has been verified as being conforming in Step b7;
Step b9: standing the magnesium alloy liquid obtained in Step b8 while controlling its temperature; and
Step b10: detecting and analyzing whether a content of iron in the magnesium alloy liquid obtained in Step b9 is conforming, and entering Step c if yes.

15. The method of claim 14, wherein in Step b, the magnesium alloy liquid is refined again while alloyed.

16. The method of claim 14 wherein in Step b4 or b5, the refining agent is added in a small amount for multiple times, and a total adding amount thereof is 15 to 25 kg/t.

17. The method of claim 14, wherein a refining duration for Step b4 or b5 is 15 to 30 min.

18. The method of claim 14 wherein in Step b5, criteria for metal elements for alloying are:
Mg: magnesium ingots of Grade 1 or better;
Al: aluminum ingots of Grade 1 or better;
Zn: zinc ingots of Grade 1 or better;
Mn: one of high-purity Al—Mn alloy, metal manganese powder with its purity greater than 99.8%, and anhydrous manganese chloride with its purity greater than 99.8%;
Be: high-purity Al—Be alloy.

19. The method of claim 18, wherein the alloy elements are optionally added in an order of: Mn, Al and Zn, Mg, and last Be.

20. The method of claim 1, wherein Step c comprising the following steps:
Step c1: preheating an ingot mold, and applying an even layer of demolding paint over an inner surface of the ingot mold;
Step c2: preheating a casting pump and a casting pipeline; and
Step c3: connecting the casting pump and the pipeline, starting a casting machine to perform casting.
